(19) United States
(12) Patent Application Publication
(10) Pub. No.: US 2014/0245881 A1
(43) Pub. Date: Sep. 4, 2014

(54) Force multiplication device

(71) Applicants: Hazem N. Hamed, Long Beach, CA (US); Tarek H. Hamed, Long Beach, CA (US)

(72) Inventors: Hazem N. Hamed, Long Beach, CA (US); Tarek H. Hamed, Long Beach, CA (US)

(21) Appl. No.: 13/815,455

(22) Filed: Mar. 4, 2013

(51) Int. Cl. F15B 15/02

(52) U.S. Cl. CPC F15B 15/02
USPC 91/189 R; 91/471

(57) ABSTRACT

Force multiplication device comprising a low power reciprocable force output device serving to energize, near the end of low force stroke thereof, a coaxially aligned coupling mechanism serving to interconnect to rear shaft of said low force reciprocable force output device, a high power reciprocable force output device comprising a plurality of coaxially disposed, connected and cooperating air cylinders resulting in availability of multiplied force throughout remainder of stroke of low power reciprocable force output device.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The disclosed invention relates to the metal forming and the spot welding industries where it is often necessary to process a workpiece using a high force actuating device serving to engage a set of a male and female dies bearing desired features to perform bending, forming, shearing, punching, stamping or any such other task on a workpiece in case of forming or engage the workpiece with a set of welding caps under a substantially elevated force in case of spot welding prior to electrical potential being applied. Under either application, a substantial initial stroke under low force is needed to engage the tooling and the workpiece followed by a substantially shorter stroke under highly intensified force serving to provide the necessary effort to process the workpiece.

### BACKGROUND OF THE INVENTION

Air over hydraulic oil presses have been used for many years to perform metalworking operations such as piercing, bending, clinching, spot welding, etc. . . . Operating on nominal shop air pressure, these types of devices provide the desirable initial long range low force travel serving to engage a workpiece followed by a relatively short stroke of hydraulically intensified output pressure serving to perform the actual metalworking task. Typically suffering from slow operation due to the inherent requirement to displace a relatively high viscosity fluid media and high maintenance due to the inevitable eventual depletion and contamination of the operating fluid thereof, these types of devices have found a niche in manufacturing due to lack of purely pneumatic low investment solution capable of delivering performance on the same order.

Toggle presses comprising a single or a number of toggle linkages coupled with oversized air cylinders successfully produce the desired force intensification but over a very narrow range at center and therefore have only been used with success for simpler operation such as rivet staking, crimping, etc. . . .

Industrial type reciprocating presses, relying on overcenter action of the reciprocating members, achieve the necessary force intensification to produce useful high output pressures over a substantially narrow range near bottom dead center. This type of equipment typically relies on inertial components serving to further elevate available pressures on-demand away from center where the work is initially engaged. Providing for the widely accepted purely mechanical solution for metalworking applications, reciprocating presses provide for the high uptime low maintenance solution but at the cost of high initial investment due to substantial weight, space requirements and high installation costs.

Preferred embodiment of the present invention comprises a novel force multiplication devise operating on standard shop air pressure serving to provide desired low force substantial initial stroke serving to engage the work, and a novel coupling mechanism serving to engage near the end of the initial stroke thereof, a plurality of coaxially aligned and thereby cooperating air cylinders serving to produce the high force output necessary to execute the desired metalworking task. Invention is aimed providing a totally pneumatic solution with better performance than toggle presses and air over oil devices in order to provide the end user with a low cost alternative for processing marginal work typically performed on large industrial presses ideally brought into the domain of lower investment smaller type equipment. Able to produce high pressures over substantial ranges, disclosed invention capitalizes on strict pneumatic operation of toggle presses combined with high force advantages of air over oil devices.

### DISCUSSION OF PRIOR ART

U.S. Pat. No. 7,685,925B2 discloses an intensifier making use of a simple air cylinder connected by means of inverted toggle coupling links to a plurality of coaxially aligned air cylinders cooperating to produce desired high output force at the end of the initial low force stroke thereof. Notwithstanding being capable of achieving a better dynamic range than conventional toggle type presses, this device comprises intricate high wear components with cam profiles, relies on mechanical friction to achieve desired output and last, suffers from severe limitations to low force advance stroke due to acceptable permissible size of inverted toggle members.

U.S. Pat. No. 7,194,859 identifies an intensifier comprising an intricate apparatus facilitating initial low force translation of the output member of the device and a plurality of coaxially aligned air cylinders cooperating to produce desired high output ram force at the end of the initial low force stroke thereof. Inventor documents that the disclosed device is presented as an alternative to conventional type toggle presses typically suffering from limited working strokes. Notwithstanding being capable of achieving a better dynamic range than a conventional toggle type press, undue complexity, unnecessary middle piston as well as large number of additional components required for this device to achieve intended purpose hinder reliable and consistent operation.

U.S. Pat. No. 7,011,019 outlines a mechanical press employing a toggle linkage serving to achieve low force substantial translation of the ram or output member of the press but makes use of an eccentric cam, once the toggle linkage reaches an overcenter locked state, in order to generate the desired high output force serving to perform useful work. Inventor documents in this disclosure that the toggle linkage employed in this design was deemed unsuitable for desired force intensification due to the extremely high forces generated if allowed to reach center during engagement of the work. The inventor, therefore, resulted to using an eccentric cam to produce the desired force intensification, or multiplication, required in the very short zone at the end of the initial stroke of this device.

U.S. Pat. No. 5,943,862 defines cushioning and stroke limiting means for the high pressure stage of an air over oil two stage hydraulic pressure transformer or intensifier making use of an air piston confined to an air chamber serving to produce low force substantial initial travel of the ram or output member of the device and extending into a high pressure oil chamber that a secondary air cylinder with a substantially smaller output shaft, upon actuation, penetrates in order to produce the desired intensified hydraulic pressure required to perform useful work in the relatively short working stroke of the device. Disclosure outlines intricate provisions requiring additional chambers, components and hydraulic fluid porting means for achieving front end and back end cushioning attainable in conventional pneumatic and hydraulic cylinders with relatively simple provisions. Aside from the complexity in achieving the highly desirable cushioning means, novelty of the disclosed invention is strictly limited to cushioning of the stroke at the end limits of extension and retraction of the ram thereby falling short of providing the highly desirable cushioning action in the middle of the stroke for controlling inherent impact at engagement position of the workpiece often resulting in attendant damage thereof when actuation of the device is performed at high speeds.

U.S. Pat. No. 5,381,661 describes an improvement to a two stage air over oil pressure intensifier entailing addition of a check valve allowing oil to flow from the low pressure oil chamber to the high pressure oil chamber in order to overcome the fundamental flaw in this design of a hydraulically locked chamber upon pressurization of the high pressure chamber necessitating the reverse stroke of cylinders of both stages to be synchronized in order to avoid cavitation of the hydraulic fluid. With this type of design widely in utilization for a number of years, the novelty of this invention amounts to facilitating the withdrawal of the small shaft of the high pressure second stage air cylinder at the arbitrary pace of the compressed return spring force allowing the displaced volume of the high pressure shaft, as it withdraws at a relatively high speed, to be replenished by flow of hydraulic fluid in the reverse direction. Invention addresses the serious problem of deterioration of the quality of the operating fluid at the cost of slower operation as the replenishing hydraulic fluid has to flow from the high pressure chamber back to the low pressure chamber in order to complete the return cycle of the device. With the resistance of hydraulic fluid to displacement being directly proportionate to the product of the viscosity and the mathematical square of the fluid flow speed, it is widely known that this type of product typically suffers from slow operation and throughput. It is therefore evident that the novelty this invention compounds the widely, known deficiency of poor throughput of this type of device which is highly undesirable.

U.S. Pat. No. 4,448,119 details a toggle press making use of two toggle linkages acting in series serving to intensify input force of a power cylinder in order to produce a substantially high output force at the ram or output member of the press. Inventor outlines in his disclosure that with each toggle linkage arrangement his press comprises achieving a mechanical advantage or force intensification factor of (5); the overall force intensification of his press is (25), which is substantial. Although this design is capable of generating very high forces, disclosure falls short of documenting that the significant force multiplication of his press is achieved in a very narrow zone where both toggle linkages reach center simultaneously.

A major manufacturer of air over oil two stage presses boasts absolute air to oil separation permitting a life cycle of 10 million cycles contingent upon the end customer performing maintenance service on the equipment on a regular basis via auxiliary oil level indicators, oil refill fittings, oil pumps and force monitoring electronic sensors and indicators. Notwithstanding the clever venting means to the ambient environment between air and oil passages that this manufacturer employs in his design, the product suffers from eventual contamination of the hydraulic fluid due to the alternating occupation of air and hydraulic media on surfaces of the high pressure shaft of the second stage cylinder and the low pressure oil cavity with every cycle. Notwithstanding the high quality finish and the advanced sealing and wiping methods of these surfaces, simultaneous deposits of both media into the crevices of these surfaces, even on a microscopic level, leads to eventual contamination and depletion of the hydraulic media and therefore the necessary regular service. Cushioning of the work stroke of the device is only offered at the end of the advance and return strokes and is achieved via utterly complex means. Option to cushion the engagement of the workpiece requires throttling of the entire working stroke of the device. Control of the working stroke is achieved via large auxiliary devices. Switching from low pressure to high pressure stage requires elaborate electrical circuits, sensors, valves or alternately tuned complex pneumatic circuits. It is clearly evident that the conventional design this manufacturer employs offers simple initial means to achieve high force intensification but the additional highly desired features in this design required to make it “production-ready” are not attainable without the addition of elaborate auxiliary provisions.

A major manufacturer of toggle presses boasts a “thin line” space saving design capable of being placed on close centers. The toggle press design of this manufacturer makes use of a partial cylindrical cavity occupying most of the volume of the device with a pneumatic vane type piston directly connected to a toggle linkage coupled to a ram providing output power. The equivalent cylinder bores that this manufacturer utilizes range from 2½″ Dia. for the (1) Ton model to over 9″ Dia. for the (20) Ton model with pressurized air consumption nearing (1) cubic foot per full stroke for the larger model. With the rated force output achievable only at very close proximities to the toggle center, this manufacturer clearly relies on oversize air cylinders in order to compensate for the low intensification characteristics of the toggle arrangement away from center. It needs to be stressed that this product suffers from poor utilization of the force of the input cylinder which is uniformly available throughout the stroke of the device but is predominantly unexploited except for a very short zone at the end of ram travel where the device is capable of achieving an acceptable force intensification level, and thereby suffers from poor efficiency.

Notwithstanding the long recognized need for a low maintenance pneumatic force multiplication device making efficient use of input power and providing high output forces over an acceptable dynamic range, an effective solution to this challenging problem has proven highly elusive. Lack of disclosed art along with lack of commercially successful and thereby available products meeting these tough criteria is further evidence to the absence of a force multiplication device with these highly desirable characteristics.

### BRIEF SUMMARY OF THE INVENTION

Inventor discloses a dual stage low air consumption force multiplication device comprising a first stage of operation where an air actuated standard pneumatic or hydraulic air cylinder serves to provide substantial low force travel, with opposite end thereof interconnected to a novel coupling mechanism serving to engage near the end of said air or hydraulic cylinder travel, a plurality of coaxially aligned, interconnected, and therefore cooperating air cylinders serving to provide a second stage of operation where the output force of said air cylinder is thereby proportionately multiplied throughout the remainder of the travel.

The novel coupling mechanism of the present invention comprises a set of pressure jaws linearly slidable in the lateral direction to the line of action of said air cylinder and serving to engage annular cavity of cap end rod clevis of said air cylinder upon reaching a predefined position permitting coupling of said air cylinder to a cooperating assembly of a plurality of air cylinders serving to proportionately multiply output force of said air cylinder throughout remainder of travel. Pressure jaws engage said air cylinder rod clevis under the action of a conical cam detail and are released from engagement position by compression springs energizing pressure jaws in the opposite lateral direction.

Making use of a standard double rod NFPA air cylinder, invention simplifies incorporation of cushioning of extension and retract strokes, minimizes cost through standardization of a major number of components, simplifies service as well as permits meeting customer standards and specifications.

Relying on a relatively short stroke to engage pressure jaws, novel coupling mechanism minimizes lost high pressure stroke of coaxially aligned cylinders during coupling to permit nearly instantaneous high pressure operation upon low pressure first stage air cylinder reaching predefined extension.

Arbitrary low force advance stroke is inherent to the design of the preferred embodiment of the present invention and is facilitated by the arbitrary stroke of the first stage air cylinder.

Arbitrary multiplied force stroke is also inherent to the design of the preferred embodiment of the present invention and is facilitated by the arbitrary stroke of second stage coaxially aligned air cylinders.

In an alternate embodiment of the present invention, a “built-in” novel switching valve is employed to automatically energize second stage air cylinders upon first stage air cylinder reaching a predefined position thereby reducing the number of actuation ports to two, a forward actuation port and a reverse actuation port yielding drastically simplified connection and sensing.

In an alternate embodiment of the present invention, an infinite adjustment provision of piston rod of first stage air cylinder permits infinite adjustment of second stage stroke.

In another alternate embodiment of the present invention, a single acting first stage pneumatic cylinder, single acting second stage air cylinders or a combination thereof serve to minimize air consumption by eliminating pressurized air demand during return strokes of the novel device.

Strictly relying on standard pneumatic actuator and mechanical components, the preferred embodiment of the present invention serves to provide the highly desirable low investment, high uptime alternative for processing work typically conducted on high investment large type reciprocating presses or maintenance prone lower cost air over oil intensification devices.

### BRIEF DESCRIPTION OF THE DRAWINGS

FIG. 1 is a sectional view of the preferred embodiment of the force multiplication device of the present invention.

FIG. 2 is a sectional view of the coupling mechanism of the preferred embodiment of the force multiplication device of the present invention.

FIG. 3 is a front view of the coupling mechanism of the preferred embodiment of the force multiplication device of the present invention.

FIG. 4 is an exploded view of the preferred embodiment of the force multiplication device of the present invention.

FIG. 5 is an exploded view of the coupling mechanism of the preferred embodiment of the force multiplication device of the present invention.

FIG. 6 is an external isometric view depicting overall construction of the preferred embodiment of the force multiplication device of the present invention.

FIG. 7 is a partial external isometric view of the rear of the preferred embodiment of the force multiplication device of the present invention.

FIG. 8 is a partial external isometric view of the preferred embodiment of the force multiplication device of the present invention making use of readily available NFPA cylinder optional mounting means.

FIG. 9 is a sectional view of alternate embodiment of the force multiplication device of the present invention incorporating an integral sequencing valve.

FIG. 10 is a sectional view of alternate embodiment of the force multiplication device of the present invention with sequencing valve in the “vent” position.

FIG. 11 is a sectional view of alternate embodiment of the force multiplication device of the present invention with sequencing valve in the “pressure” position.

FIG. 12 is a sectional view of alternate embodiment of the force multiplication device of the present invention with a sequencing valve incorporated into first stage air cylinder shown just prior to coupling position.

FIG. 13 is a sectional view of alternate embodiment of the force multiplication device of the present invention with a sequencing valve incorporated into first stage air cylinder shown just after coupling.

FIG. 14 is a sectional view of alternate embodiment of the force multiplication device of the present invention with a sequencing valve incorporated into first stage air cylinder shown in return stroke.

FIG. 15 is a sectional view of a coupling mechanism making use of pivoting elements of an alternate embodiment of the force multiplication device of the present invention in the released position.

FIG. 16 is a front view of a coupling mechanism coupling member making use of pivoting elements of an alternate embodiment of the force multiplication device of the present invention in the released position.

FIG. 17 is a sectional view of a coupling mechanism making use of pivoting elements of an alternate embodiment of the force multiplication device of the present invention in the engaged position.

FIG. 18 is a front view of a coupling mechanism coupling member making use of pivoting elements of an alternate embodiment of the force multiplication device of the present invention in the engaged position.

FIG. 19 is an exploded view of a coupling mechanism making use of pivoting elements of an alternate embodiment of the force multiplication device of the present invention.

FIG. 20 is a sectional view of a coupling mechanism making use of a unitized body coupling element of an alternate embodiment of the force multiplication device of the present invention in the released position.

FIG. 21 is a front view of a unitized body coupling element of an alternate embodiment of the force multiplication device of the present invention in the released position.

FIG. 22 is a sectional view of a coupling mechanism making use of a unitized body coupling element of an alternate embodiment of the force multiplication device of the present invention in the engaged position.

FIG. 23 is a front view of a unitized body coupling element of an alternate embodiment of the force multiplication device of the present invention in the engaged position.

FIG. 24 is an exploded view of a coupling mechanism making use of a unitized body coupling element of an alternate embodiment of the force multiplication device of the present invention.

FIG. 25 is a sectional view an alternate embodiment of the force multiplication device of the present invention making use of single acting first and second stage cylinders.

FIG. 26 is a sectional view of an alternate embodiment of the force multiplication devise of the present invention making use of an infinitely adjustable rod extension provision of first stage cylinder.

FIG. 27 is a sectional view of an alternate embodiment of the force multiplication device of the present invention making use of sliding coupling elements and minimal number of components to render acceptable operation.

FIG. 28 is a sectional view of the coupling mechanism of an alternate embodiment of the force multiplication device of the present invention making use of sliding coupling elements and minimal number of components to render acceptable operation.

FIG. 29 is front and side views of a coupling member with sliding coupling elements of an alternate embodiment of the force multiplication device of the present invention making use gib slots to result in a minimum number of components necessary to render acceptable operation.

FIG. 30 is an exploded view of the coupling mechanism of an alternate embodiment of the force multiplication device of the present invention making use of sliding coupling elements and minimal number of components to render acceptable operation.

FIG. 31 is a sectional view of an alternate embodiment of the force multiplication device of the present invention with a coupling mechanism making use of a unitized body coupling element and a minimum number of components to render acceptable operation shown in the released position.

FIG. 32 is a front view of a unitized body coupling element of an alternate embodiment of the force multiplication device of the present invention in the released position.

FIG. 33 is a sectional view of an alternate embodiment of the force multiplication device of the present invention with coupling mechanism making use of a unitized body coupling element and a minimum number of components to render acceptable operation shown in the engaged position.

FIG. 34 is a front view of a unitized body coupling element of an alternate embodiment of the force multiplication device of the present invention shown in the engaged position.

FIG. 35 is an exploded view of a coupling mechanism making use of a unitized body coupling element and a minimum number of components to render acceptable operation of an alternate embodiment of the force multiplication device of the present invention.

FIG. 36 is a sectional view of an alternate embodiment of the force multiplication device of the present invention with a coupling mechanism making use of pivoting elements and a minimum number of components to render acceptable operation shown in the released position.

FIG. 37 is a front view of a coupling member with pivoting elements of an alternate embodiment of the force multiplication device of the present invention shown in the released position.

FIG. 38 is a sectional view of an alternate embodiment of the force multiplication device of the present invention with a coupling mechanism making use pivoting elements and a minimum number of components to render acceptable operation shown in the engaged position.

FIG. 39 is a front view of a coupling member with pivoting elements of an alternate embodiment of the force multiplication device of the present invention shown in the engaged position.

FIG. 40 is an exploded view of a coupling mechanism making use of pivoting elements and a minimum number of components to render acceptable operation of an alternate embodiment of the force multiplication device of the present invention.

### DETAILED DESCRIPTION OF THE PREFERRED EMBODIMENT

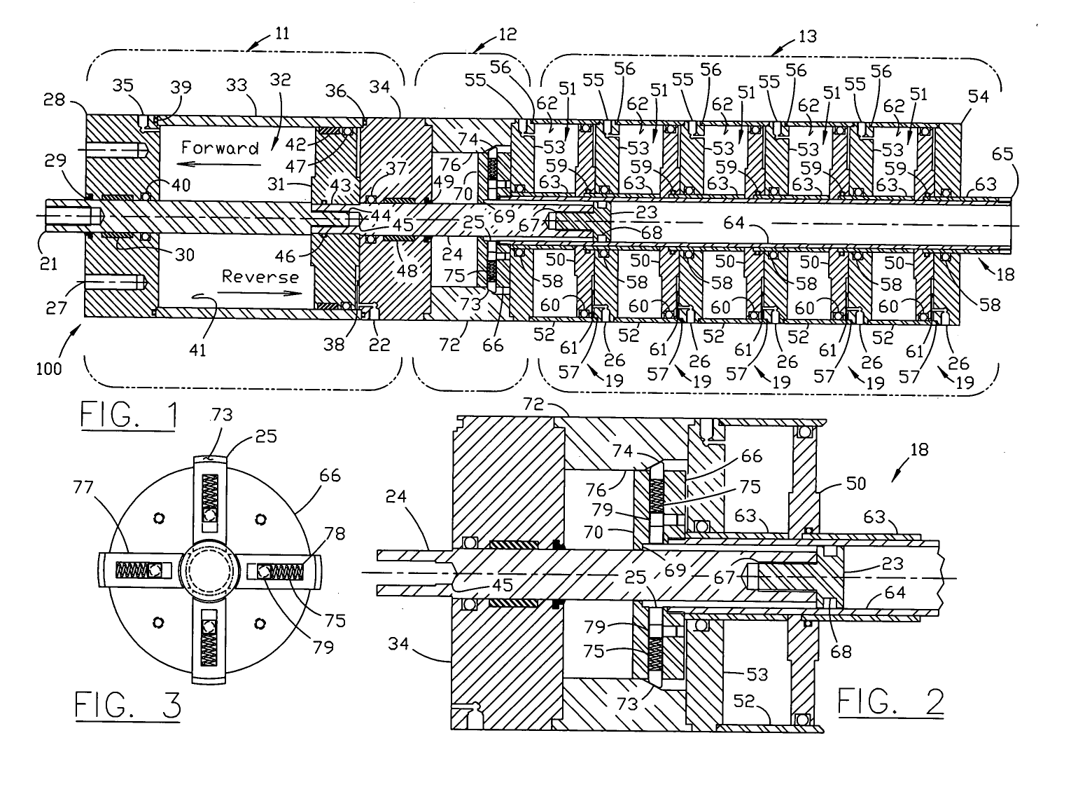

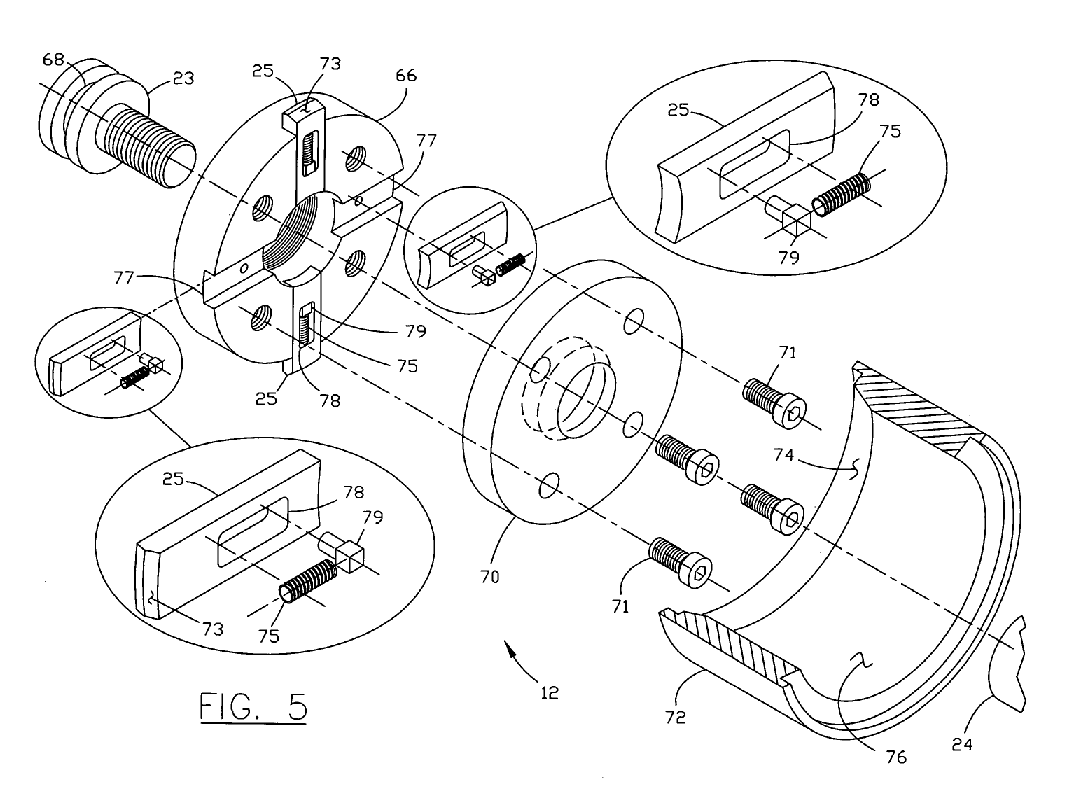

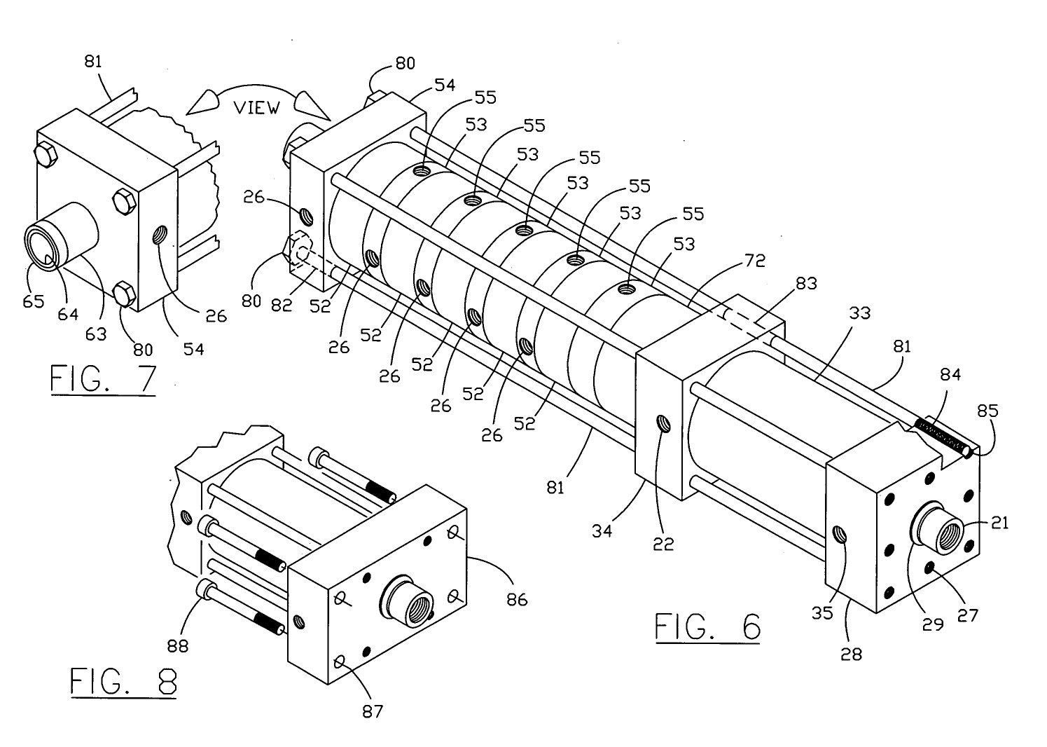

### Preferred Embodiment Construction—FIGS. 1-8.

With reference to FIGS. 1-8, the preferred embodiment 100 of the force multiplication device of the present invention comprises low power reciprocable force output device, nominal force air cylinder 11 and high power reciprocable force output device, force multiplication system 13 disposed on opposing sides of force multiplication coupling system 12 with nominal force air cylinder 11 serving to provide a first stage of operation with substantial linear travel to workpiece engagement position (not shown) at nominal output force thereof through front piston rod 21 by means of application of standard shop air pressure to port 22, with pressure clevis 23 permanently affixed to rear piston rod 24 serving to capture, upon nominal force air cylinder 11 reaching a predefined position, a singularity or plurality of pressure jaws 25 of force multiplication coupling system 12, serving to directly interconnect nominal force air cylinder 11 to force multiplication system 13 comprising a plurality of coaxially aligned and tandem interconnected air cylinders 19 serving to provide a second stage of operation where output force of front piston rod 21 of nominal force air cylinder 11 is proportionately multiplied through simultaneous application of standard shop air pressure to all forward actuation ports 26 of cooperating air cylinders 19, through workpiece engagement position throughout remainder of travel and to final extended position (not shown) relative to workpiece tooling accurately fixtured to nominal force air cylinder 11 through mounting holes set 27 of front end cap 28 of preferred embodiment 100 of the force multiplication devise of the present invention.

Nominal force air cylinder 11 of preferred embodiment 100 of the present invention comprises output member front piston rod 21 protected from outside environment by scraper 29, retained against side load by annular bearing 30 and actuated in the forward and reverse directions by piston 31 slidably operable in cavity 32 disposed between cylinder tube 33, front end cap 28 and rear end cap 34 through alternating application of compressed air through forward actuation port 22 and reverse actuation port 35, with rear crush seal 36 and rear dynamic piston rod seal 37 serving to retain compressed air in rear cavity 38 upon forward actuation and forward crush seal 39 and front dynamic piston rod seal 40 serving to retain compressed air in front cavity 41 upon reverse actuation. Piston 31 is retained in the lateral direction by annular bearing 42 and amongst numerous means of construction, is captive between front piston rod 21 and rear piston rod 24 over reduced diameter front extension 43 of rear piston rod 24 via affixation of reduced extension 44 of front piston rod 21 into receiving end 45 of rear piston rod 24 with static seal 46 serving to retain compressed air from escaping through inner diameter of piston 31 and dynamic seal 47 serving to retain compressed air from escaping through outside diameter thereof as piston 31 alternates between rear cavity 38 and front cavity 41.

Additional lateral support to nominal force air cylinder 11 is provided by rear annular bearing 48 with scraper 49, standard components of supply on standard double rod air cylinder employed in preferred embodiment 100 of the present invention. Readily available cushioning provisions and piston bumpers for standard supply double rod air cylinder are equally applicable to preferred embodiment 100 of the present invention notwithstanding that they are not illustrated in FIG. 1.

Force multiplication system 13 of the referred embodiment 100 of the present invention comprises plurality of coaxially disposed and tandem interconnected air cylinders 19 comprising pistons 50 slidably operable in cavities 51 disposed between cylinder tubes 52, end caps 53 and rear end cap 54 through alternating application of compressed air to forward actuation ports 26 and reverse actuation ports 55 with forward crush seals 56, rear crush seals 57, dynamic seals 58 of end caps 53 and 54 along with inside diameter static seals 59 and outer diameter dynamic seals 60 of pistons 50 serving to retain compressed air in piston rear cavities 61 and piston front cavities 62 as compressed air is applied for forward actuation of pistons 50 through ports 26 and rear actuation through ports 55. Pistons 50 are accurately disposed in cavities 51 in the axial direction in relation to end caps 53 and 54 by spacers 63 confined between front and rear faces pistons 50 while tightly fitting outer diameter of pressure tube 64 and which along with pistons 50 are captive under axial preload force between retention nut 65 permanently affixed to rear end of pressure tube 64 and coupling chuck 66 of force multiplication coupling system 12 permanently affixed to front end of pressure tube 64 resulting in pistons 50, spacers 63, pressure tube 64, retention nut 65 as well as inside diameter static seals 59 and outer diameter dynamic seals 60, hereafter simply referred to as force multiplication piston assembly 18, along with coupling chuck 66 translating as one integral assembly as pressure is applied through ports 26 for forward actuation and through one or more of ports 55 for reverse actuation thereof.

Force multiplication coupling system 12 of the referred embodiment 100 of the present invention comprises pressure clevis 23 slidably operable in pressure tube 64 of force multiplication system 13 and permanently affixed to receiving diametral portion 67 of rear piston rod 24 of nominal force air cylinder 11, coupling chuck 66 permanently affixed to front end of pressure tube 64 along with mating slidably operable in the radial direction pressure jaws 25 serving to capture annular cavity 68 of pressure clevis 23 upon substantial forward travel of nominal force air cylinder 11 and engagement of pressure clevis 23 with reduced diametral portion 69 of stop plate 70 permanently affixed to coupling chuck 66 under preload force of plurality of screws 71 and annular reaction sleeve 72 axially disposed between rear end cap 34 of nominal force air cylinder 11 and front end cap 53 of force multiplication system 13, serving to energize pressure jaws 25 in the inward radial direction through contact of conical ends 73 of pressure jaws 25 with conical internal surface 74 thereof against force of jaw springs 75 with full engagement taking place upon pressure jaws 25 reaching constant diametral portion 76 of annular reaction sleeve 72 resulting in coupling of force multiplication system 13 and nominal force air cylinder 11 upon substantial forward travel thereof. Consistent and reliable sliding operation of pressure jaws 25 in the radial direction is facilitated by accurately fitting mating pressure bearing slots 77 in coupling chuck 66 and positive retention in the axial direction by stop plate 70 with pressure jaws 25 energized in the outward radial direction by jaw springs 75 linearly operable in spring slots 78 of pressure jaws 25 and bearing against slot pins 79 permanently affixed to coupling chuck 66 with square heads protruding into but not overextending spring slots 78 of pressure jaws 25. Reverse motion of nominal force air cylinder 11 and consequently pressure clevis 23 results in release of pressure clevis 23 from engagement of pressure jaws 25 under action of jaw springs 75 as conical ends 73 of pressure jaws 25 recede narrowing contact of conical surface 74 of annular reaction sleeve 72.

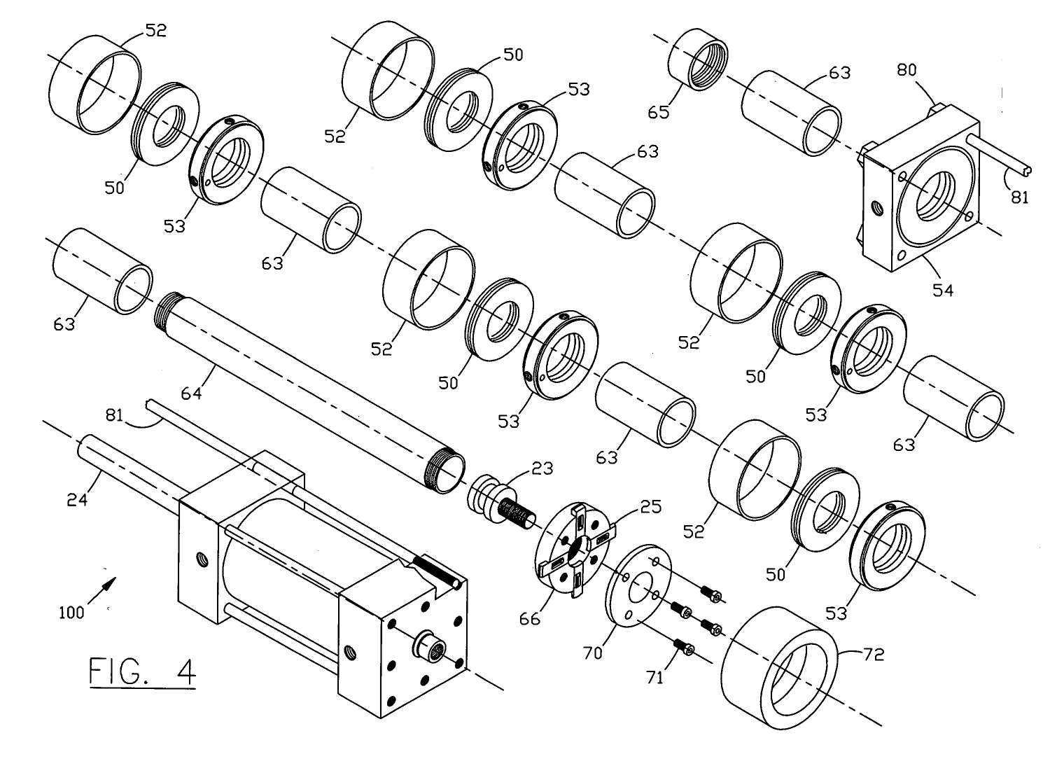

With reference to FIGS. 4, 6, 7 and 8, heads 80 of tierods 81 extending through holes 82 in rear end cap 54 of force multiplication system 13 and through holes 83 in rear end cap 34 of nominal force air cylinder 11 with threaded ends 84 secured into receiving tapped holes 85 of front end cap 28 of nominal force air cylinder 11 serve to secure rear end cap 54, cylinder tubes 52, end caps 53, annular reaction sleeve 72, rear end cap 34, cylinder tube 33 to front end cap 28 of nominal force air cylinder 11, all sandwiched together in compression forming one integral external body of preferred embodiment 100 of the present invention.

With reference to FIG. 8, an alternate mounting configuration of the present invention makes use of laterally extended front end cap 86 with through holes 87 for mounting using screws 88, one of numerous mounting options readily available on standard NFPA cylinders.

### Preferred Embodiment Operation—FIGS. 1-8.

With reference to FIGS. 1-7, with work (not shown) properly fixtured to preferred embodiment 100 of the present invention through mounting holes 27, standard shop air pressure is applied to port 22 of nominal force air cylinder 11 with each of reverse actuation port 35 of nominal force air cylinder 11, forward actuation ports 26 and reverse actuation ports 55 of force multiplication system 13 vented to atmospheric pressure through proper pneumatic connections, nominal force air cylinder 11 advances toward work engagement position. Forward translation of nominal force air cylinder 11 continues until pressure clevis 23 of rear piston rod 24 engages reduced diametral portion 69 of stop plate 70 forcing forward movement thereof and consequently permanently affixed thereto coupling chuck 66 forcing forward movement of permanently affixed force multiplication piston assembly 18 with slidably operable pressure jaws 25 translating in the inward radial direction due to forced engagement of conical ends 73 and forward narrowing conical surface 74 of annular reaction sleeve 72 forcing engagement of pressure jaws 25 with properly aligned receiving annular cavity 68 of pressure clevis 23 with full penetration thereto taking place upon conical ends 73 of pressure jaws 25 reaching constant diametral portion 76 of annular reaction sleeve 72 resulting in coupling of force multiplication system 13 and nominal force air cylinder 11 as engagement position with work is reached. Proper electrical or mechanical sensing apparatus (not shown) is employed to deliver air pressure to forward actuation ports 26 of force multiplication system 13 forcing multiplication of force exerted by front piston rod 21 of nominal force air cylinder 11 through force exerted onto rear piston rod 24 through pressure clevis 23 through pressure jaws 25 through coupling chuck 66 through piston spacers 63 through air pressure acting on pistons 50 in unison through work engagement position (not shown) thereby processing work until final position (not shown) is reached.

Cycle reverses through simultaneous application of standard shop air to reverse actuation port 35 of nominal force air cylinder 11 and reverse actuation ports 55 of force multiplication system 13 with simultaneous venting to atmospheric pressure of forward actuation port 22 of nominal force air cylinder 11 and forward actuation ports 26 of force multiplication system 13. Reverse travel in unison of front piston rod 21, piston 31, rear piston rod 24 of nominal force air cylinder 11 takes place along with pressure clevis 23, pressure jaws 25, coupling chuck 66 and force multiplication piston assembly 18 of force multiplication system 13 with pressure jaws 25 receding in the outward radial direction under force of jaw springs 75 upon conical ends 73 of pressure jaws 25 departing engagement with constant diametral portion 76 of annular reaction sleeve 72 followed by rearward diametrally expanding conical surface 74 resulting in full disengagement of pressure jaws 25 from receiving annular cavity 68 of pressure clevis 23 under the action of springs 75 resulting in de-coupling of nominal force air cylinder 11 from force multiplication piston assembly 18 of force multiplication system 13 allowing each to return separately back to retracted position.

Alternate Embodiment with Integral Sequencing Valve—FIGS. 9-11

With reference to FIGS. 9 through 11, alternate embodiment 101, predominantly a duplication of preferred embodiment 100 of the force multiplication device of the present invention comprises nominal force air cylinder 111, an exact replica of nominal force air cylinder 11 of preferred embodiment 100, force multiplication coupling system 112, an exact replica of force multiplication coupling system 12 of preferred embodiment 100 and force multiplication system 113, a duplication of force multiplication system 13 of preferred embodiment 100 augmented with sequencing valve system 114 serving to energize force multiplication system 113 upon coupling of nominal force air cylinder 111 thereof upon predefined low force travel by nominal force air cylinder 111 being reached.

With reference to FIG. 9, alternate embodiment 101 additionally comprises forward actuation manifold 121 serving to supply compressed air through forward actuation port 122 of alternate embodiment 101 of the present invention to forward actuation port 123 of nominal force air cylinder 111 and forward energize port 124 of sequencing valve system 114, rear actuation manifold 125 serving to supply compressed air through reverse actuation port 126 of alternate embodiment 101 to reverse actuation port 127 of nominal force air cylinder 111 and reverse actuation ports 128 of force multiplication system 113 and sequencing manifold 129 serving to switch through connection to sequencing port 130 of sequencing valve system 114, forward actuation ports 131 of force multiplication system 113 between sequencing vent port 132 connected to atmospheric pressure through flow control valve 133 and breather 134 facilitating controlled deceleration of nominal force air cylinder 111 upon initial actuation of force multiplication system 113 and forward energize port 124 serving to deliver compressed air pressure to force multiplication system 113 for multiplied force output at nominal force air cylinder 111.

Sequencing valve system 114 comprises valve body 135 permanently affixed to rear end cap 136 of force multiplication system 113 by mounting screws 137 with annular cavity 138 sealed from outside environment by crush seal 139 at rear end cap 136 of force multiplication system 113 and rear dynamic seal 140 acting against outside diameter of retention nut 141 serving to retain in compression components of force multiplication piston assembly 118 comprising coupling chuck 142, piston spacers 143, pistons 144 and sequencing spool 145 over pressure tube 146 in a predominantly similar manner to multiplication piston assembly 18 of preferred embodiment 100 with addition of sequencing spool 145 serving to internally switch forward actuation ports 131 of force multiplication system 113 through sequencing port 130 of sequencing valve system 114, from sequencing vent port 132 serving to force deceleration of nominal force air cylinder 111 through controlled initial translation of force multiplication piston assembly 118 upon pressure clevis 147 of force multiplication coupling system 112 reaching stop plate 148 through flow control valve 133 and breather 134 to forward energize port 124 serving to deliver compressed air to power force multiplication system 113 upon pressure jaws 149 reaching constant diametral surface 150 of annular reaction sleeve 151 forcing engagement of pressure jaws 149 with receiving annular cavity 152 of pressure clevis 147 thereby coupling force multiplication system 113 and nominal force air cylinder 111 just prior to work (not shown) being reached.

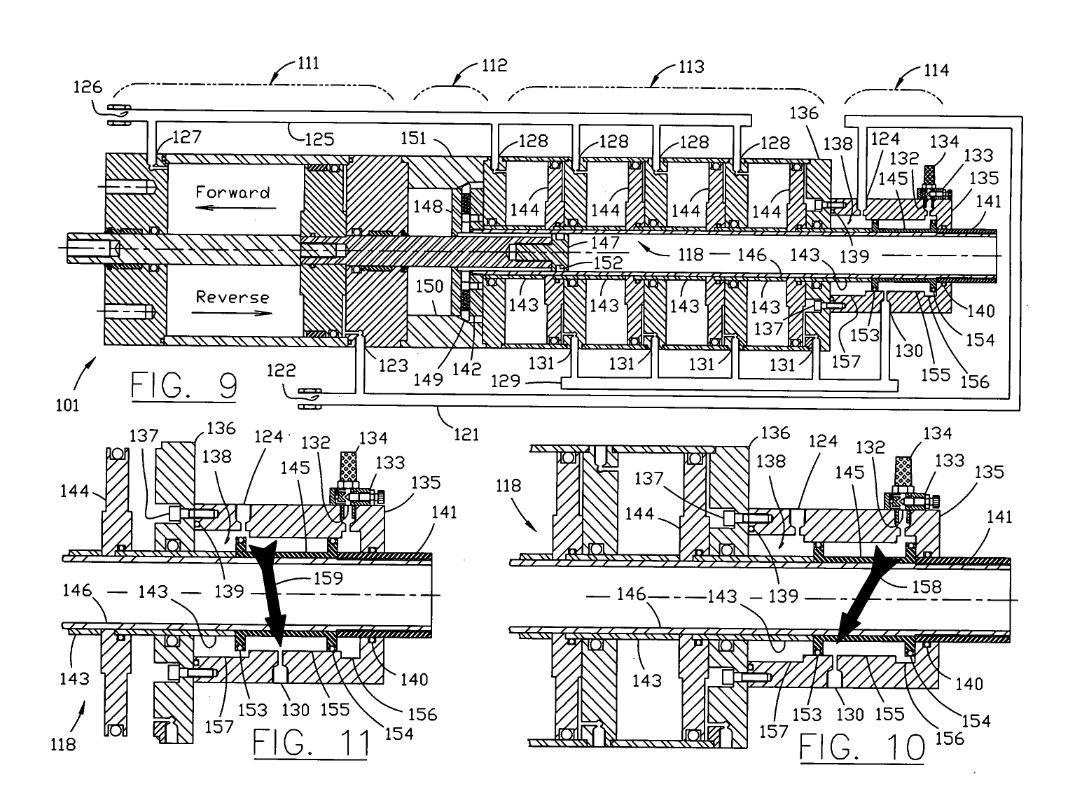

With reference to FIGS. 10 and 11, sequencing spool 145 directly connected to force multiplication piston assembly 118 serves to provide desired pneumatic connection to force multiplication system 113 through front spool seal 153 and rear spool seal 154 each alternately making full contact with annular sealing surface 155 while other simultaneously losing contact thereto upon reaching venting annular relief surface 156 or pressure annular relief surface 157 thereby facilitating venting connection depicted by arrow 158 in FIG. 10 or compressed air connection depicted by arrow 159 in FIG. 11.

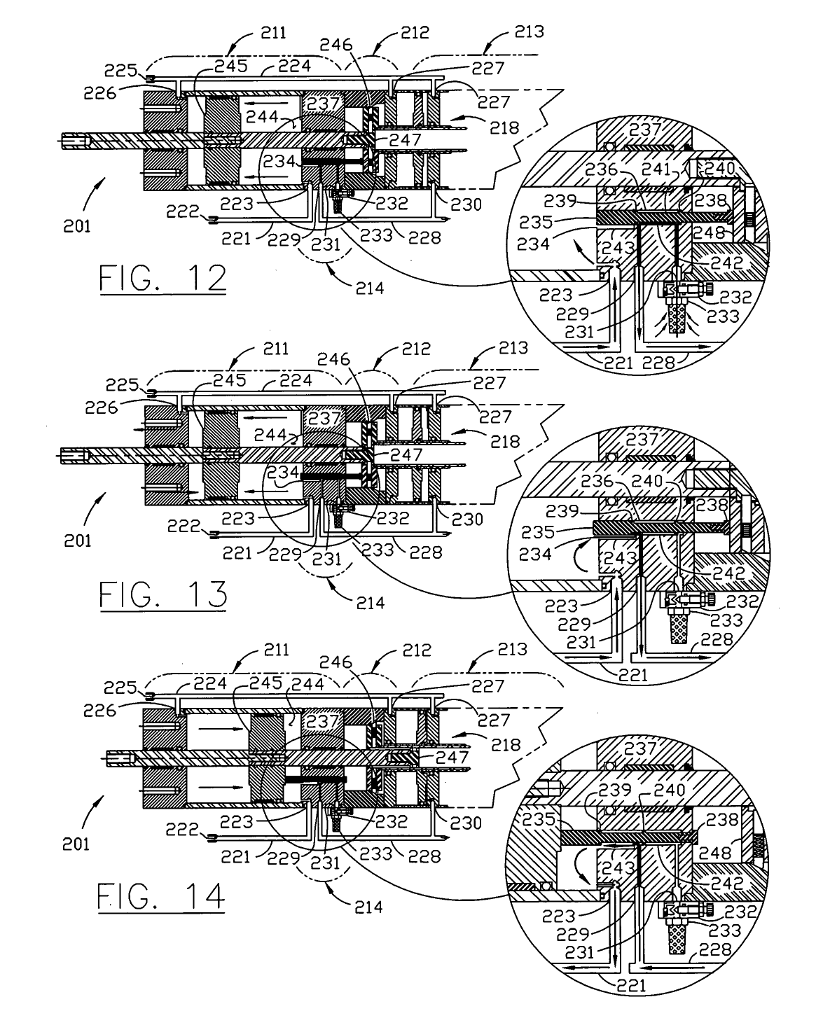

Alternate Embodiment with Simplified Integral Sequencing Valve—FIGS. 12-14

With reference to FIGS. 12 through 14, alternate embodiment 201, predominantly a duplication of alternate embodiment 101 of the force multiplication device of the present invention comprises force multiplication coupling system 212 an exact replica of force multiplication coupling system 12 of preferred embodiment 100 of the present invention, force multiplication system 213, an exact replica of force multiplication system 13 of preferred embodiment 100 of the present invention and nominal force air cylinder 211 predominantly a duplication nominal force air cylinder 11 of preferred embodiment 100 of the present invention with sequencing valve system 214, functionally a duplication of sequencing valve system 114 of alternate embodiment 101 of the present invention incorporated within.

Alternate embodiment 201 additionally comprises forward actuation manifold 221 serving to supply compressed air through forward actuation port 222 of alternate embodiment 201 of the force multiplication system of the present invention to forward actuation port 223 of nominal force air cylinder 211, rear actuation manifold 224 serving to supply compressed air through reverse actuation port 225 of alternate embodiment 201 to reverse actuation port 226 of nominal force air cylinder 211 and reverse actuation ports 227 of force multiplication system 213, and sequencing manifold 228 serving to alternate through connection to sequencing port 229 of sequencing valve system 214, forward actuation ports 230 of force multiplication system 213 between vent port 231 connected to atmospheric pressure through flow control valve 232 and breather 233 facilitating controlled deceleration of nominal force air cylinder 211 upon initial coupling thereof to force multiplication system 213 and forward energize port 234 serving to deliver compressed air pressure to force multiplication system 213 for multiplied force output at nominal force air cylinder 211.

Sequencing valve system 214 of alternate embodiment 201 comprises spool 235 slidably operable in annular cavity 236, disposed between front and rear faces of end cap 237 of nominal force air cylinder 211, strike button 238, front seal 239 and rear seal 240 spanning recessed spool stem 241 serving to alternate pneumatic connection of port 229 between air passage 242 leading to vent port 231 and air passage 243 leading to forward energize port 234 open to forward traverse pressure chamber 244 of nominal force air cylinder 211. With reference to FIG. 12, spool 235 is shown, just prior to engagement of coupling system 212, in vent position under the action of piston 245 upon returning to retracted position from previous cycle with front seal 239, rear seal 240 and recessed spool stem 241 serving to open air passage 242 serving to connect sequencing port 229 to vent port 231 as well as simultaneously close air passage 243 serving to connect sequencing port 229 to pressure port 234.

With reference to FIG. 12 again, operating in a predominantly similar manner to alternate embodiment 101 of the force multiplication device of the present invention, upon pressure jaws 246 engaging pressure clevis 247 thereby coupling nominal force air cylinder 211 of alternate embodiment 201 to pressure multiplication system 213 and with port 226 and ports 227 vented to ambient pressure along with ports 230 connected through port 229 of sequencing valve system 214 to vent port 231, air is metered in through breather 233 and flow control valve 232 resulting in deceleration of nominal force air cylinder 211 just prior to engagement of work (not shown) just as nominal force air cylinder 211 forces forward translation of piston assembly 218, an exact replica of piston assembly 18 of preferred embodiment 100 of the present invention. With reference to FIG. 13, forward motion continues until stop plate 248, an exact replica of stop plate 70 of preferred embodiment 100 of the present invention makes contact with strike button 238 forcing spool 235 to shift forward consequently closing air passage 242 simultaneous to opening of air passage 243 serving to connect forward actuation ports 230 of force multiplication system 213 through sequencing port 229 to pressure port 234, resulting in forward actuation of piston assembly 218 of force multiplication system 213 under full air pressure leading to multiplied force output at nominal force air cylinder 211, engagement and processing of work (not shown) through remainder stroke of nominal force air cylinder 211.

With reference to FIG. 14, cycle reverses resulting in pressurized air delivery to port 226 of nominal force air cylinder 211 and ports 227 of force multiplication system 213 through reverse actuation port 225 simultaneous to venting of port 223 of nominal force air cylinder 211 through port 222 leading to additional venting of ports 230 of force multiplication system 213 through sequencing port 229 and open air passage 243 leading through port 234 to vented chamber 244 of nominal force air cylinder 211 resulting in reverse travel of nominal force air cylinder 211 in unison with piston assembly 218 of force multiplication system 213 until coupling mechanism 214 fully disengages, with piston assembly 218 returning to fully retracted position and finally piston 245 striking and shifting spool 235 back to vent position forcing closure of air passage 243 and opening of air passage 242 connecting forward actuation ports 230 of force multiplication system 213 to vent port 231 in preparation for the next cycle with nominal force air cylinder 211 returning to fully retracted position.

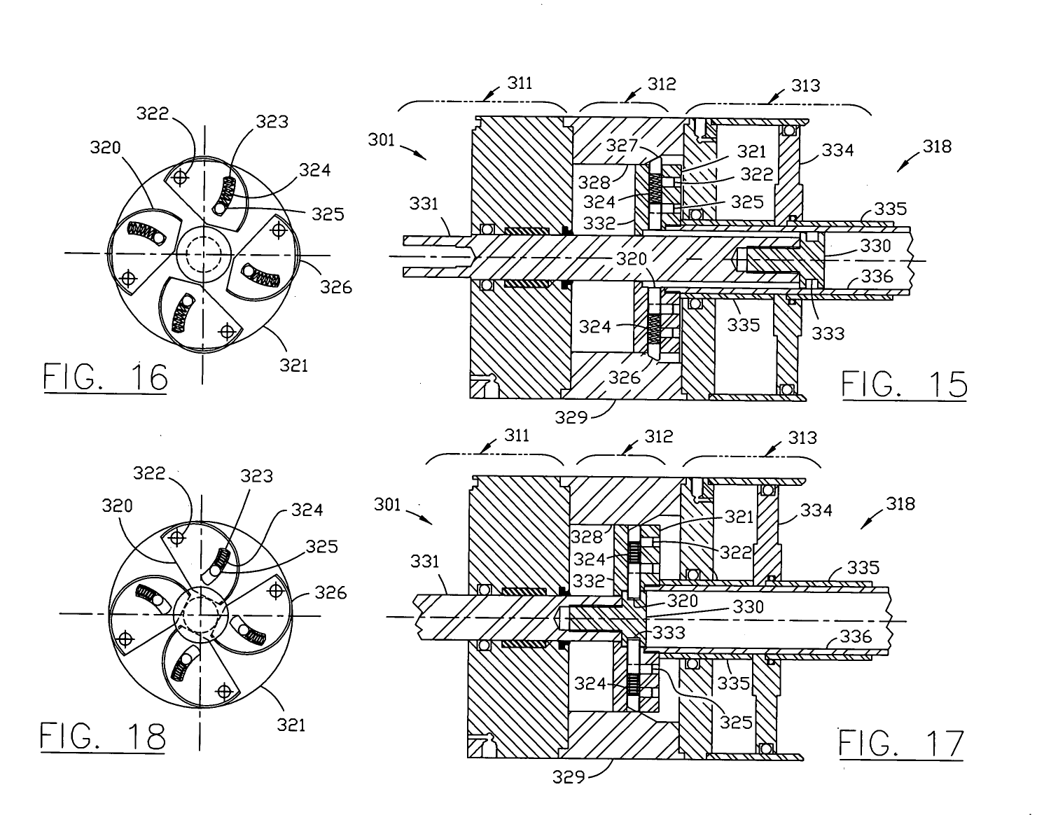

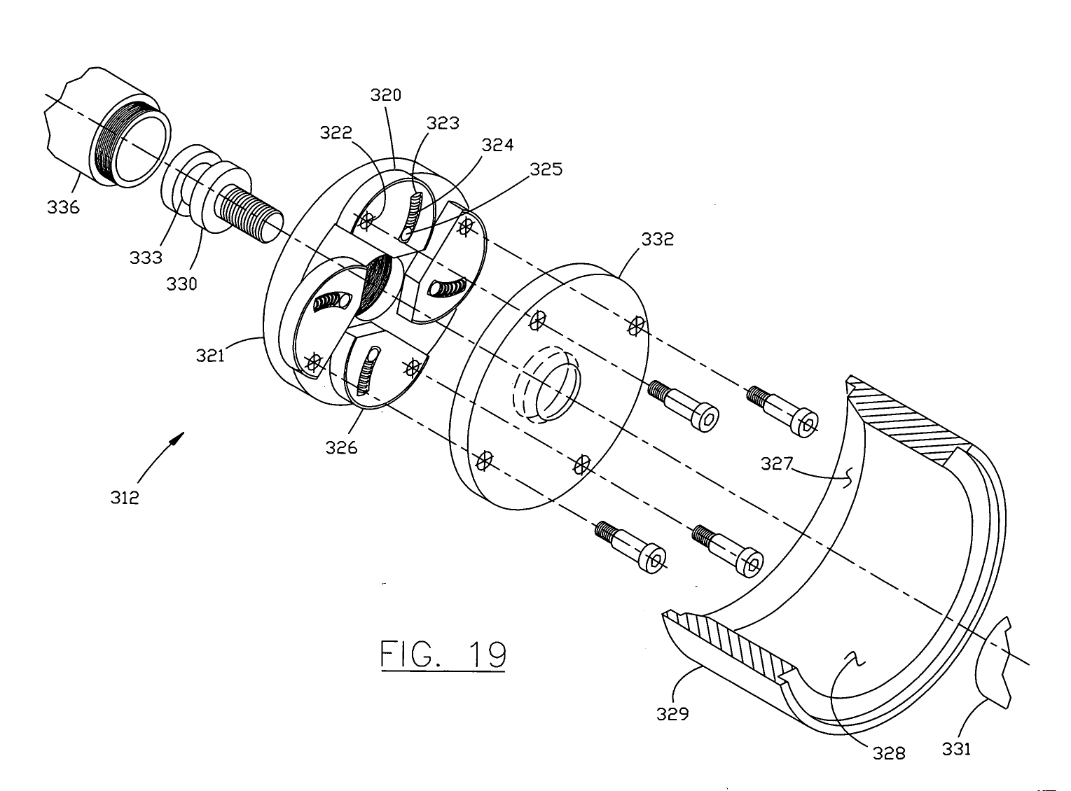

Alternate Embodiment with Pivoting Pressure Jaws—FIGS. 15-19

With reference to FIGS. 15-19, alternate embodiment 301, predominantly a duplication of preferred embodiment 100 of the force multiplication device of the present invention, comprises nominal force air cylinder 311, an exact replica of nominal force air cylinder 11 of preferred embodiment 100, force multiplication system 313, an exact replica duplication of force multiplication system 13 of preferred embodiment 100 and force multiplication coupling system 312 functionally a duplication of force multiplication coupling system 12 of preferred embodiment 100 of the present invention employing a plurality of pressure jaws 320 pivotably connected to coupling chuck 321 through pivot pins 322 with jaw slots 323 serving to retain compression springs 324 serving to actuate pressure jaws 321 in the outward radial direction by acting against slot pins 325 permanently affixed to coupling chuck 321 thereby forcing profiled surfaces 326 of pressure jaws 320 to make constant contact with conical surface 327 and subsequently constant diametral surface 328 of annular reaction sleeve 329, a duplication of annular reaction sleeve 72 of preferred embodiment 100 of the present invention, upon pressure clevis 330, an exact replica of pressure clevis 23 of preferred embodiment 100 of the present invention, permanently affixed to rear piston rod 331 of nominal force air cylinder 311, engaging stop plate 332, a replica of stop plate 70 of preferred embodiment 100 of the present invention, upon forward travel of nominal force air cylinder 311, forcing forward movement of coupling chuck 320 and actuation of pressure jaws 321 in the inward radial direction forcing engagement with receiving annular cavity 333 of pressure clevis 330 resulting in coupling of pressure multiplication system 313 and nominal force air cylinder 311 in exact manner of coupling of pressure multiplication system 13 to nominal force air cylinder 11 of preferred embodiment 100 of the present invention. Followed by application of air pressure to force multiplication system 313, collective output force of piston assembly 318, an exact replica of piston assembly 18 of preferred embodiment 100 of the present invention entailing a duplicate arrangement of pistons 334, spacers 335 and pressure tube 336, is transmitted through coupling chuck 321, through pressure jaws 320, through pressure clevis 330 and finally to nominal force air cylinder 311 resulting in force multiplication of output force thereof in exactly the same manner as that of preferred embodiment 100 of the present invention.

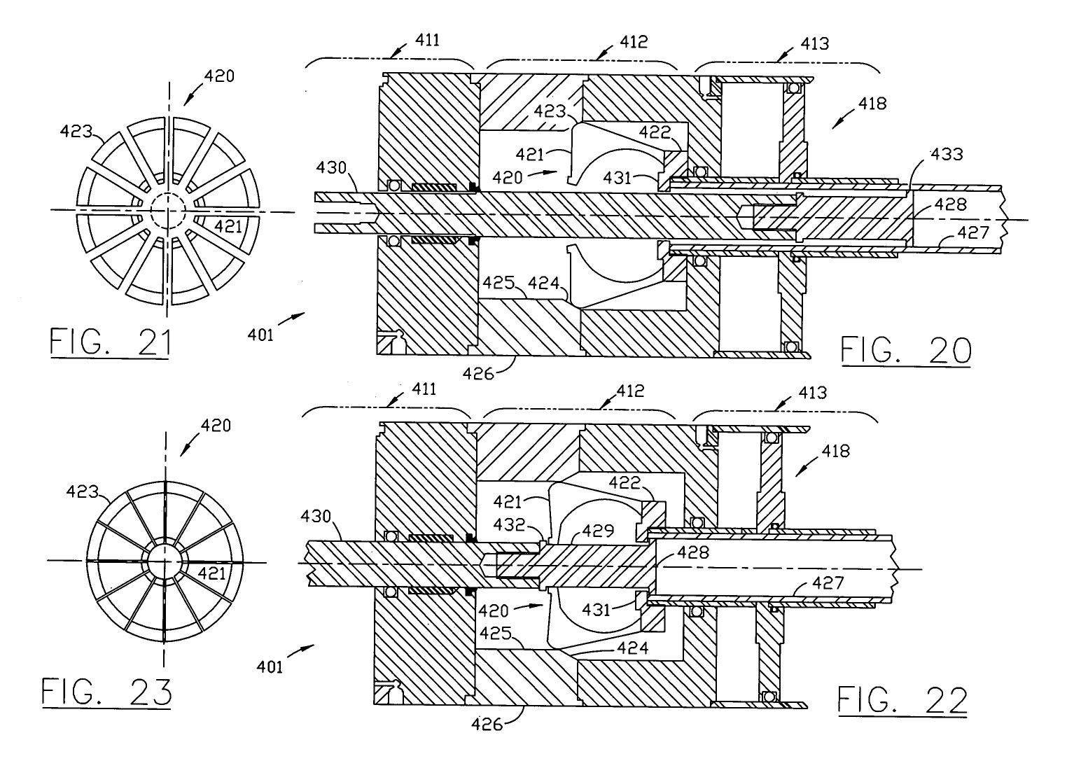

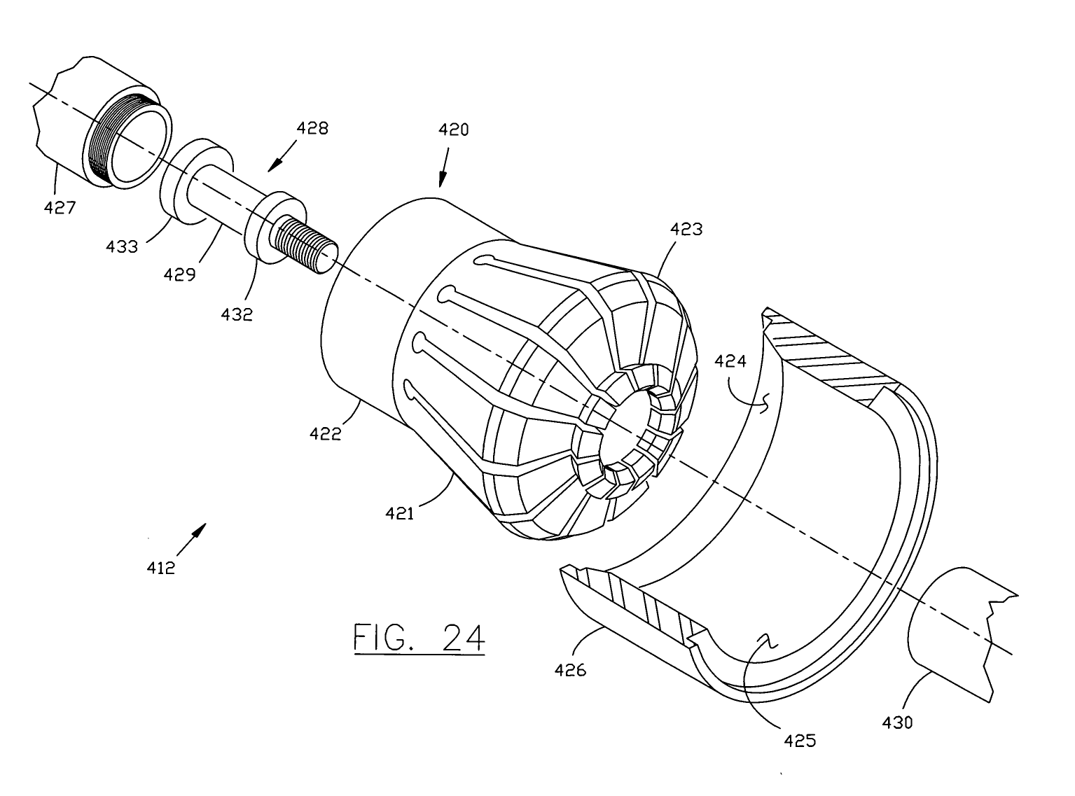

Alternate Embodiment with Unitized Body Coupling Chuck—FIGS. 20-24

With reference to FIGS. 20-24, alternate embodiment 401, predominantly a duplication of preferred embodiment 100 of the present invention, comprises nominal force air cylinder 411, an exact replica of nominal force air cylinder 11 of preferred embodiment 100, force multiplication system 413, an exact replica duplication of force multiplication system 13 of preferred embodiment 100 and force multiplication coupling system 412 functionally a duplication of force multiplication coupling system 12 of preferred embodiment 100 of the present invention making use of unitized body coupling chuck 420 comprising bifurcating pressure jaws 421, compliant in the radial direction but properly engineered to naturally return to their fully expanded form in the free state, integral to and cantilevering from coupling chuck main body 422, and with properly profiled surfaces 423 serving to engage conical surface 424 and subsequently constant diametral surface 425 of annular reaction sleeve 426, predominantly a duplication of annular reaction sleeve 72 of preferred embodiment 100 of the present invention upon forward translation thereof serving to couple coupling chuck 420 and permanently affixed thereto pressure tube 427, a duplication of pressure tube 64 of preferred embodiment 100 of the present invention, and thereby force multiplication piston assembly 418, an exact replica of force multiplication piston assembly 18 of preferred embodiment 100 of the present invention, to pressure clevis 428 through contact of pressure jaws 421 with receiving annular cavity 429 of pressure clevis 428 permanently affixed to rear piston rod 430 of nominal force air cylinder 411 of alternate embodiment 401 as pressure clevis 428 engages diametral stop extension 431 of coupling chuck 420 resulting in coupling of pressure multiplication system 413 to nominal force air cylinder 411 in a predominantly similar manner of coupling of pressure multiplication system 13 to nominal force air cylinder 11 of preferred embodiment 100 of the present invention. Properly engineered pressure clevis diameter 432 marginally smaller than diameter of stop extension 431 permits escapement thereof upon forward motion of nominal force air cylinder 411 with engagement of pressure clevis 428 with stop extension 431 taking place upon contact of properly engineered larger diameter 433 thereof forcing forward movement of coupling chuck 420 resulting in translation of pressure jaws 421 in the inward radial direction due contact between profiled surfaces 423 and forward contracting conical surface 424 forcing engagement thereof with receiving annular cavity 429 of pressure clevis 428 and subsequently force of piston assembly 418 being transmitted through pressure jaws 421 of coupling chuck 420, through pressure clevis 428, to nominal force air cylinder 411 upon application of air pressure to force multiplication system 413.

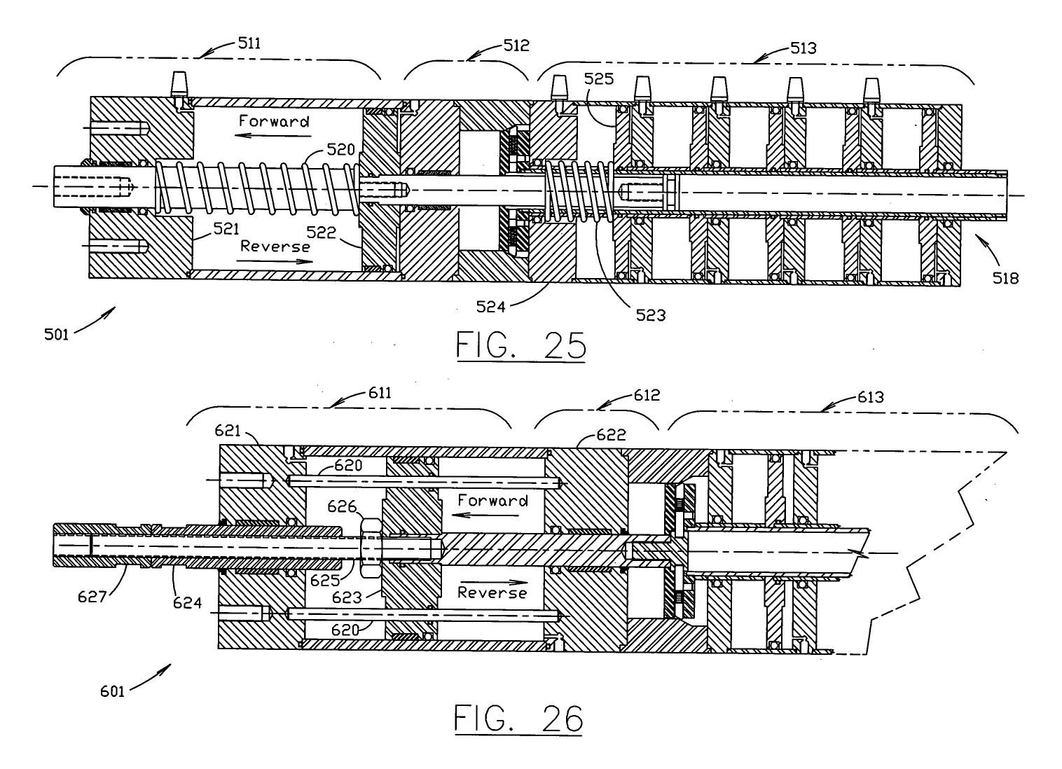

Alternate Embodiment with Spring Return—FIG. 25

With reference to FIG. 25, with nominal force air cylinder 511, force multiplication coupling system 512 and force multiplication system 513 predominantly duplications of nominal force air cylinder 11, force multiplication coupling system 12 and force multiplication system 13 of preferred embodiment 100 of the present invention respectively, and with operation in the forward direction exactly a duplication of that of the preferred embodiment 100 of the present invention, alternate embodiment 501 of the present invention endeavors to minimize air consumption during the reverse stroke of alternate embodiment 501 of the present invention through spring return of nominal force air cylinder 511 or spring return of force multiplication system 513 or both through compression spring 520 forcing return of nominal force air cylinder 511 by forcing separation of front end cap 521 and piston 522 and compression spring 523 forcing return of piston assembly 518 of force multiplication system 513 by forcing separation of front end cap 524 of force multiplication system 513 and forward piston 525 of piston assembly 518.

Alternate Embodiment with Infinite Extension Adjustment—FIG. 26

With reference to FIG. 26, with force multiplication system 613 and force multiplication coupling system 612 exact replicas of force multiplication system 13 and force multiplication coupling system 12 of preferred embodiment 100 of the present invention respectively, alternate embodiment 601 incorporates infinite adjustment to extension of nominal force air cylinder 611, predominantly a duplication of nominal force air cylinder 11 of preferred embodiment 100 of the present invention, comprising shafts 620 affixed to and spanning between front end cap 621 and rear end cap 622 and passing through piston 623 thereby restraining piston 623 from rotation during infinite adjustment of extension of piston rod 624 threadably adjustable to fixed threaded rod 625 secured to piston 623 through pressure nut 626 with securing threaded rod 627 permitting locking of piston rod 624 in position upon adjustment.

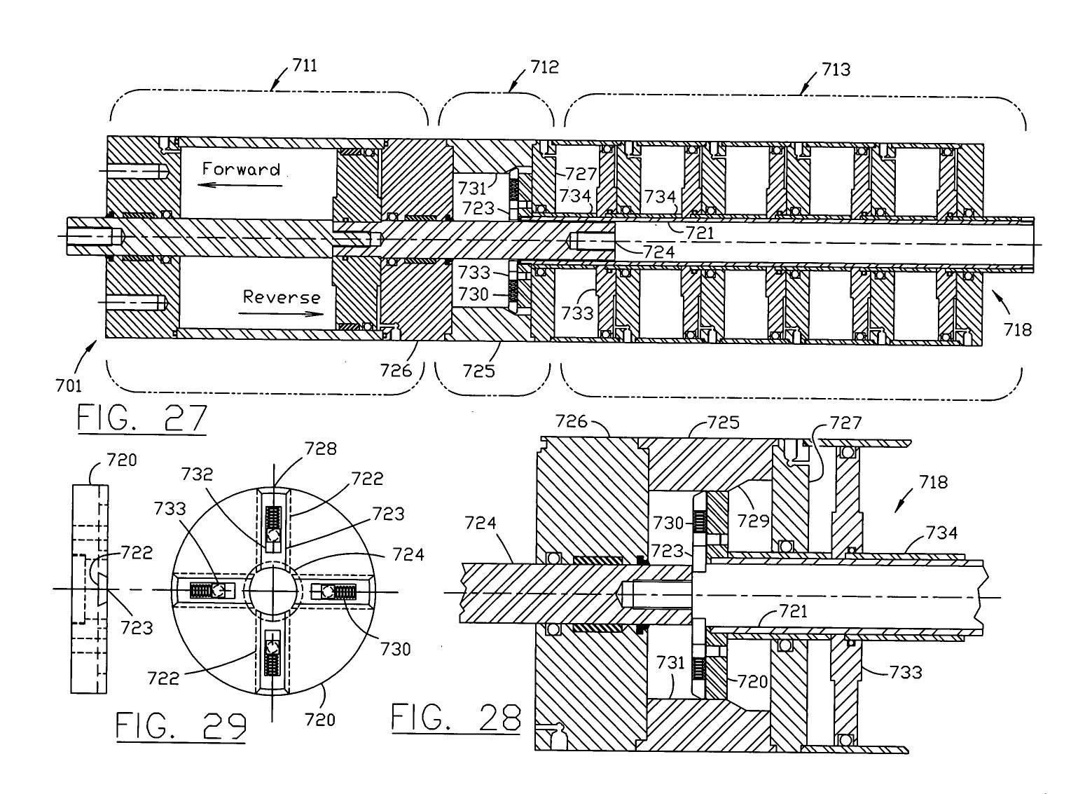

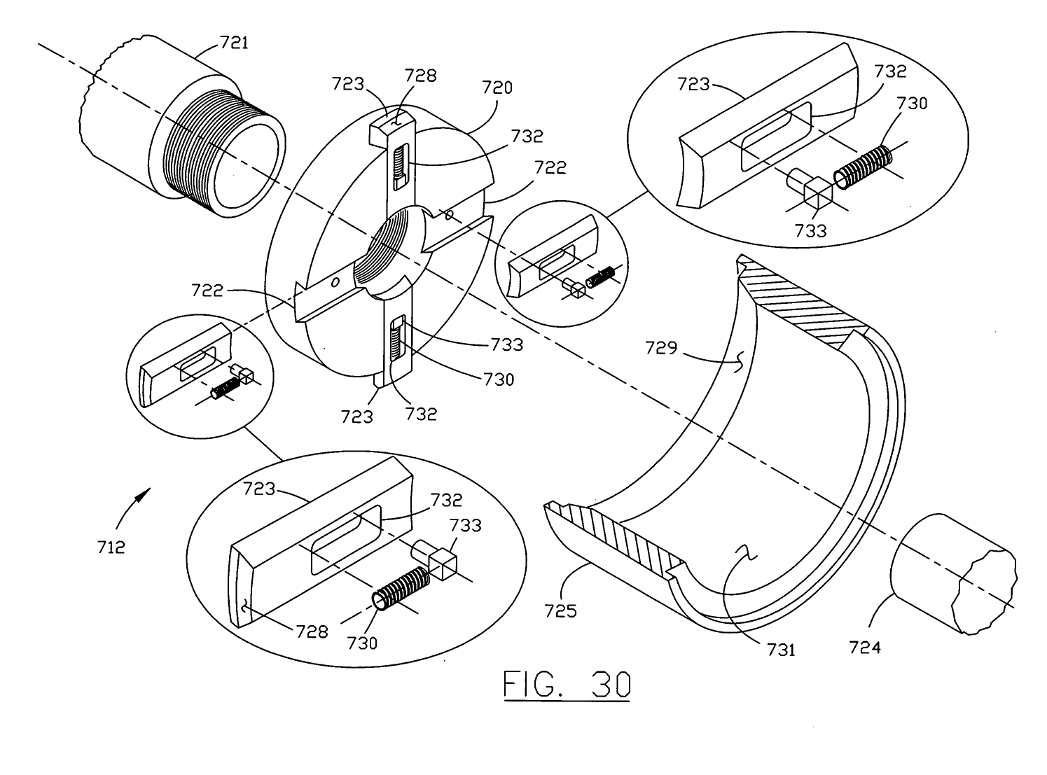

Alternate Embodiment with Sliding Pressure Jaws—FIGS. 27-30

With reference to FIGS. 27-30, alternate embodiment 701, predominantly a duplication of preferred embodiment 100 of the present invention, comprises nominal force air cylinder 711, an exact replica of nominal force air cylinder 11 of preferred embodiment 100, force multiplication system 713, an exact replica duplication of force multiplication system 13 of preferred embodiment 100 and force multiplication coupling system 712 functionally a duplication of force multiplication coupling system 12 of preferred embodiment 100 of the present invention with minimal number of components necessary to render acceptable operation.

Force multiplication coupling system 712 of alternate embodiment 701 of the present invention comprises coupling chuck 720 permanently affixed to front end of pressure tube 721 with gib slots 722 serving as guides and positive retention means restricting movement of plurality of mating pressure jaws 723 solely to sliding in the radial direction to permit direct action against rear face of rear piston rod 724 of nominal force air cylinder 711 upon substantial forward travel thereof, and annular reaction sleeve 725 axially disposed between rear end cap 726 of nominal force air cylinder 711 and front end cap 727 of force multiplication system 713, serving to energize pressure jaws 723 in the inward radial direction through contact of conical ends 728 thereof with conical internal surface 729 of annular reaction sleeve 725 against force of jaw springs 730 with full engagement taking place upon pressure jaws 723 reaching constant diametral portion 731 of annular reaction sleeve 725 resulting in coupling of force multiplication system 713 and nominal force air cylinder 711 upon substantial forward travel thereof. Consistent and reliable sliding operation of pressure jaws 723 in the radial direction is facilitated by accurately fitting mating pressure bearing gib slots 722 in coupling chuck 720 with pressure jaws 723 energized in the outward radial direction by jaw springs 730 linearly operable in spring slots 732 of pressure jaws 723 and bearing against slot pins 733 permanently affixed to coupling chuck 720 with square heads protruding into but not overextending spring slots 732 of pressure jaws 723.

Alternate embodiment 701 emulates operation of that of preferred embodiment 100 of the present invention by actuation of force multiplication system 713 upon confirmation by either mechanical or electronic sensing means that nominal force air cylinder 711 has reached predefined position where rear face of rear piston rod 724 has advanced substantially past pressure jaws 723. Upon actuation of force multiplication system 713, coupling chuck 720 is energized in the forward direction thereby actuating pressure jaws 723 in the inward radial direction with full radial inward extension thereof reached prior to making contact with rear face of rear piston rod 724 of nominal force air cylinder 711. Cycle continues and force of nominal air cylinder 711 throughout remainder of stroke thereof is henceforth multiplied by action of force multiplication system 713 transferring full force through collective output force of piston assembly 718, an exact replica of piston assembly 18 of preferred embodiment 100 of the present invention entailing a duplicate arrangement of pistons 733, spacers 734 and pressure tube 721, through coupling chuck 720, through pressure jaws 723 acting directly on rear face of rear piston rod 724 of nominal force air cylinder 711. Cycle reverses and each of nominal force air cylinder 711 and force multiplication system 713 return independently with return speed of force multiplication system ideally set somewhat higher than that of nominal force air cylinder 711 in order to alleviate any undue pressure from rear piston rod 724 of nominal force air cylinder 711 onto pressure jaws 723.

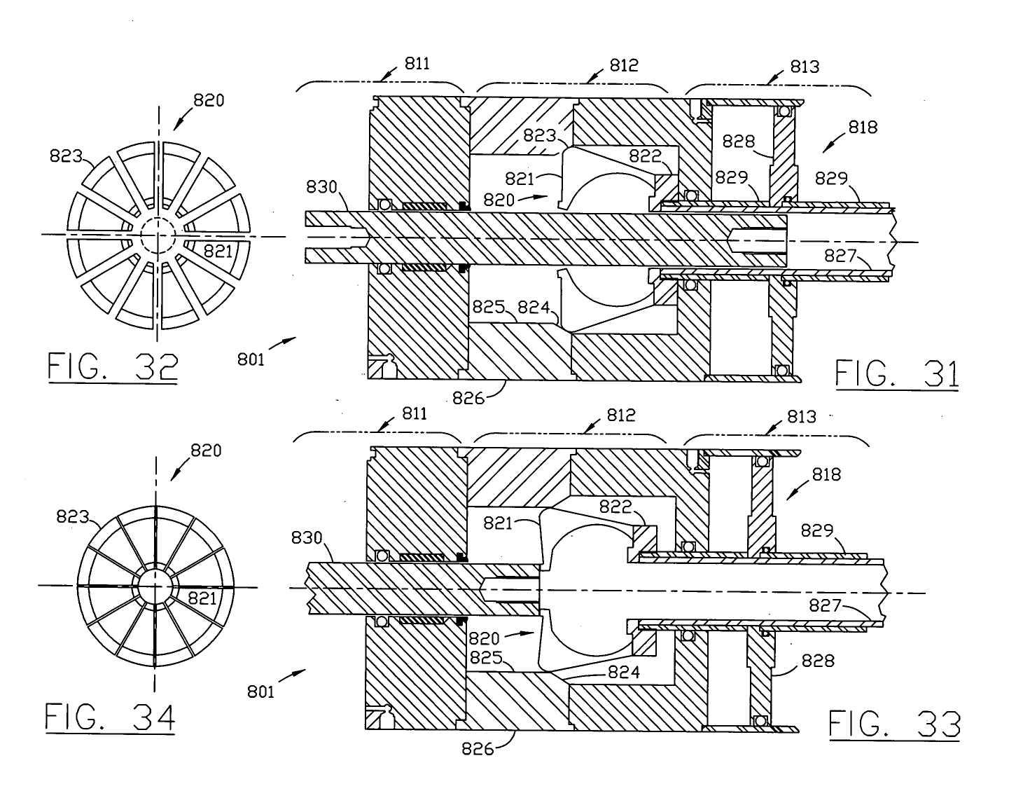

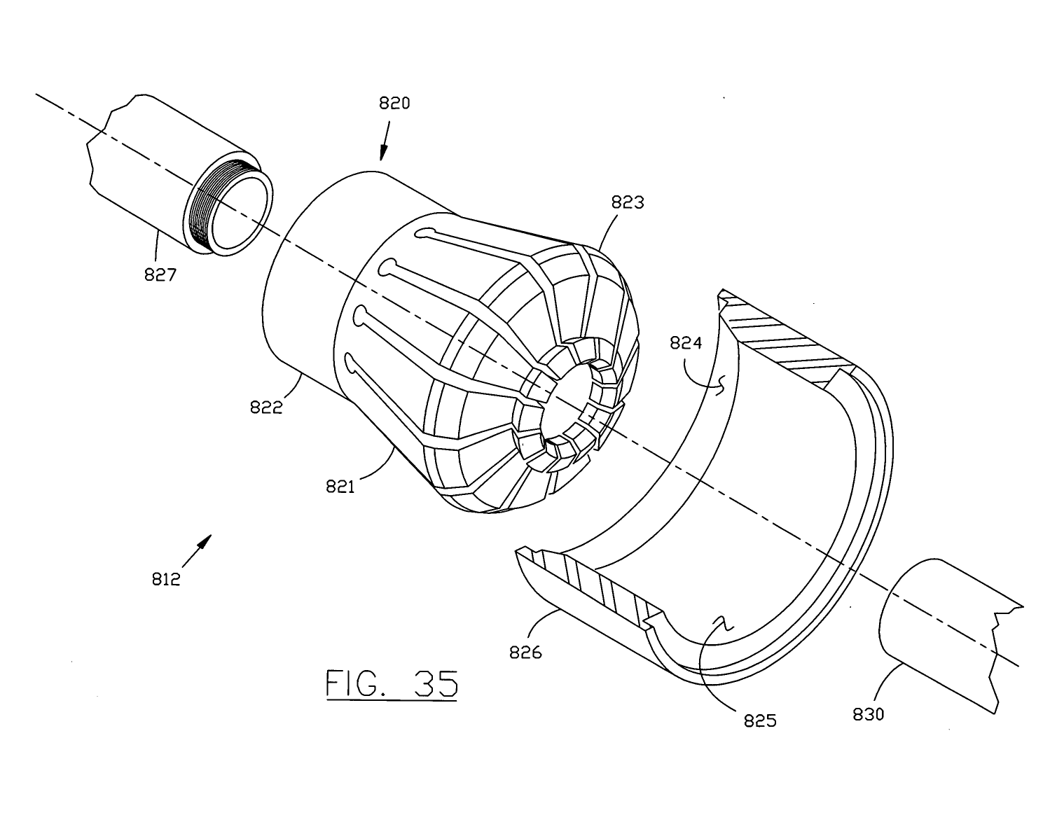

Alternate Embodiment with Unitized Body Coupling Chuck—FIGS. 31-35

With reference to FIGS. 31-35, alternate embodiment 801, predominantly a duplication of preferred embodiment 100 of the present invention, comprises nominal force air cylinder 811, an exact replica of nominal force air cylinder 11 of preferred embodiment 100, force multiplication system 813, an exact replica duplication of force multiplication system 13 of preferred embodiment 100 and force multiplication coupling system 812 functionally a duplication of force multiplication coupling system 12 of preferred embodiment 100 of the present invention with a minimal number of components necessary to render acceptable operation.

Force multiplication coupling system 812 of alternate embodiment 801 comprises unitized body coupling chuck 820 with bifurcating pressure jaws 821, compliant in the radial direction but properly engineered to naturally return to their fully expanded form in the free state, integral to but cantilevering from chuck main body 822, and with properly profiled surfaces 823 serving to engage conical surface 824 and subsequently constant diametral surface 825 of annular reaction sleeve 826, predominantly a duplication of annular reaction sleeve 72 of preferred embodiment 100 of the present invention upon forward translation thereof serving to couple coupling chuck 820 and permanently affixed thereto pressure tube 827, a duplication of pressure tube 64 of preferred embodiment 100 of the present invention, and thereby force multiplication piston assembly 818 an exact replica of force multiplication piston assembly 18 of preferred embodiment 100 of the present invention entailing a duplicate arrangement of pistons 828, spacers 829 and pressure tube 827, to nominal force air cylinder 811 through direct action against rear face of rear piston rod 830.

Alternate embodiment 801 emulates operation of that of preferred embodiment 100 of the present invention by actuation of force multiplication system 813 upon confirmation by either mechanical or electronic sensing means that nominal force air cylinder 811 has reached predefined position where rear face of rear piston rod 828 has advanced substantially past bifurcating pressure jaws 821 of coupling chuck 820. Upon actuation of force multiplication system 813, coupling chuck 820 is energized in the forward direction thereby actuating pressure jaws 821 in the inward radial direction through contact of profiled surfaces 823 of bifurcating pressure jaws 821 with forward narrowing conical surface 824 of reaction sleeve 826 with full inward radial extension thereof reached upon profiled surfaces 823 reaching constant diametral portion 825 of reaction sleeve 826 just prior to making contact with rear face of rear piston rod 830 of nominal force air cylinder 811. Cycle continues and force of nominal air cylinder 811 throughout remainder of stroke thereof is henceforth multiplied by action of force multiplication system 813 transferring full force through coupling chuck 820, through bifurcating pressure jaws 821 acting directly on rear face of rear piston rod 828 of nominal force air cylinder 811. Cycle reverses and each of nominal force air cylinder 811 and force multiplication system 813 return independently with return speed of force multiplication system set somewhat higher than that of nominal force air cylinder 811 in order to alleviate any undue pressure from rear face of rear piston rod 830 of nominal force air cylinder 811 onto pressure jaws 821 integral to and bifurcating from chuck main body 822 of coupling chuck 820.

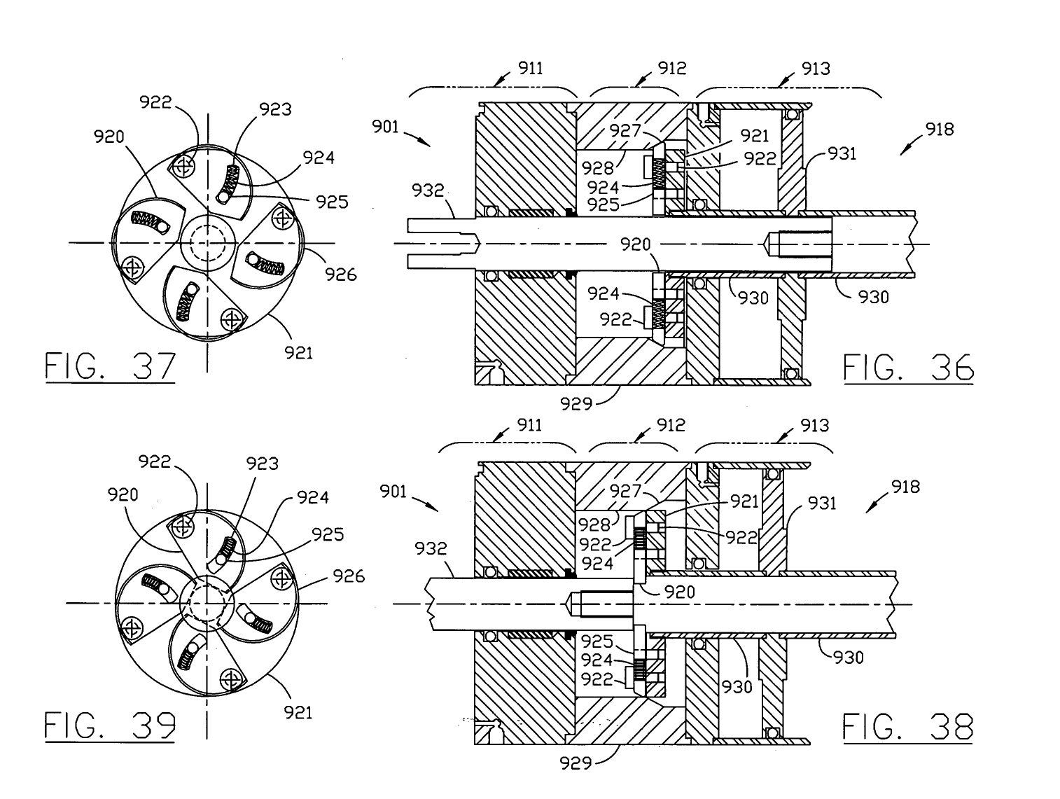

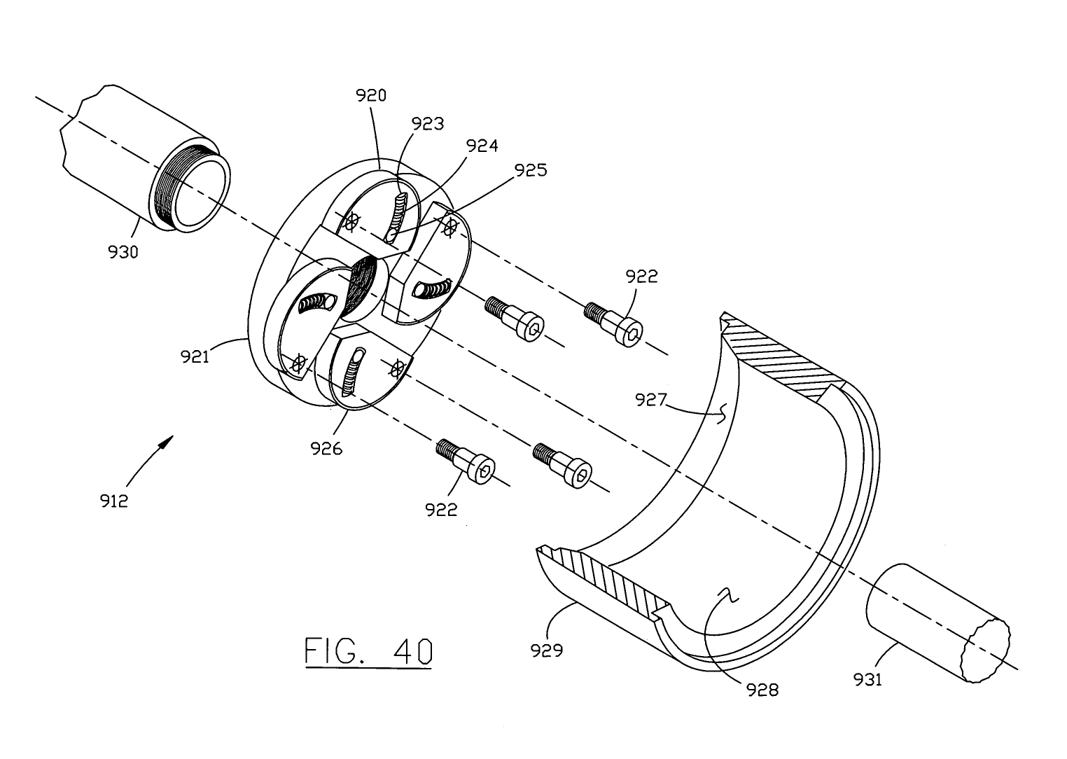

Alternate Embodiment with Pivoting Pressure Jaws—FIGS. 36-40

With reference to FIGS. 36-40, alternate embodiment 901, predominantly a duplication of preferred embodiment 100 of the present invention, comprises nominal force air cylinder 911, an exact replica of nominal force air cylinder 11 of preferred embodiment 100, force multiplication system 913, predominantly a duplication of force multiplication system 13 of preferred embodiment 100 and force multiplication coupling system 912 functionally a duplication of force multiplication coupling system 12 of preferred embodiment 100 of the present invention with minimal number of components necessary to render acceptable operation.

Force multiplication coupling system 912 comprises plurality of pressure jaws 920 pivotably connected to coupling chuck 921 through pivot shoulder bolts 922 with jaw slots 923 serving to retain compression springs 924 serving to actuate pressure jaws 920 in the outward radial direction by acting against slot pins 925 permanently affixed to coupling chuck 921 thereby forcing profiled surfaces 926 of pressure jaws 920 to make constant contact with conical surface 927 and subsequently constant diametral surface 928 of annular reaction sleeve 929, a duplication of annular reaction sleeve 72 of preferred embodiment 100 of the present invention, upon forward translation of pressure jaws 920 serving to couple coupling chuck 921 and permanently affixed thereto forward most pressure member of plurality of pressure spacers 930, permanently secured to and therefore spanning pistons 931 and thereby acting in lieu of combination of pressure tube 64 and spacers 63 of preferred embodiment 100 of the present invention, and thereby force multiplication piston assembly 918 predominantly a replica of force multiplication piston assembly 18 of preferred embodiment 100 of the present invention, to nominal force air cylinder 911 through direct action against rear face of rear piston rod 932.

Alternate embodiment 901 emulates operation of that of preferred embodiment 100 of the present invention by actuation of force multiplication system 913 upon confirmation by either mechanical or electronic sensing means that nominal force air cylinder 911 has reached predefined position where rear face of rear piston rod 932 has advanced substantially past pressure jaws 920 of coupling chuck 921. Upon actuation of force multiplication system 913, coupling chuck 921 is energized in the forward direction thereby actuating pressure jaws 920 in the inward radial direction through contact of profiled surfaces 926 with forward narrowing conical surface 927 of reaction sleeve 929 with full radial inward extension thereof reached upon profiled surfaces 926 of pressure jaws 920 reaching constant diametral portion 928 of reaction sleeve 929 just prior to making contact with rear face of rear piston rod 932 of nominal force air cylinder 911. Cycle continues and force of nominal air cylinder 911 throughout remainder of stroke thereof is henceforth multiplied by action of force multiplication system 913 transferring full force through coupling chuck 921, pressure jaws 920 acting directly on rear face of rear piston rod 932 of nominal force air cylinder 911. Cycle reverses and each of nominal force air cylinder 911 and force multiplication system 913 return independently with return speed of force multiplication system ideally set somewhat higher than that of nominal force air cylinder 911 in order to alleviate any undue pressure from rear piston rod 932 of nominal force air cylinder 911 onto pressure jaws 920 of coupling chuck 921.

What is claimed is:

1. Force multiplication device for supplying incremental force, the force multiplication device comprising:
a) A low power reciprocable force output device including a rear shaft with permanently affixed connection means bearing a recessed portion, and a forward shaft serving as force output means of said force multiplication device,
b) A high power reciprocable force output device including a plurality of coaxially aligned, interconnected and cooperating pneumatic cylinders with a common force output shaft bearing a permanently affixed connection means with laterally operable plurality of cam actuated pressure jaws, and with stopping means for said connection means of said low power reciprocable force output device for proper alignment of said plurality of pressure jaws of said connection means of said high power reciprocable force output device and said recessed portion of said connection means of said low power force output device, and
c) A coupling means adjoining said low power reciprocable force output device and said high power reciprocable force output device including a cam actuation detail for urging said pressure jaws of said connection means of said high power output device in the inward radial direction upon forward actuation thereof,
Whereby said low power reciprocable force output device at the end of substantial low force stroke thereof urges forward movement of said high power reciprocable force output device through engagement of said connection means of said low force reciprocable force output device with said stopping means of said connection means of said high power reciprocable force output device and lateral actuation of said pressure jaws of said connection means of said high power reciprocable force output device forcing engagement thereof with said recessed portion of said connection means of said low force reciprocable force output device resulting in said high power reciprocable force output device and said low power reciprocable force output device being mechanically locked and thereby capable of delivery of proportionately multiplied force of said high power reciprocable force output device throughout remainder of stroke of said low power reciprocable force output device.

2. Force multiplication device of claim 1 wherein said pressure jaws are slidably operable in said connection means of said high power reciprocable force output device.

3. Force multiplication device of claim 1 wherein said pressure jaws are pivotably operable in said connection means of said high power reciprocable force output device.

4. Force multiplication device of claim 1 wherein said connection means of said high power reciprocable force output device is of unitized construction including bifurcating pressure jaws.

5. Force multiplication device of claim 1 wherein said low power reciprocable force output device is a single acting spring return pneumatic cylinder.

6. Force multiplication device of claim 1 wherein said high power reciprocable force output device includes single acting spring return pneumatic cylinders.

7. Force multiplication device of claim 1 wherein said output shaft of said low power reciprocable force output device is threadably adjustable over a threaded rod permanently affixed to piston of low power reciprocable force output device, said piston being rotatably captive through a set of shaft interconnecting front and rear caps of low power reciprocable force output device and passing through said piston.

8. Force multiplication device of claim 1 further including an air valve with spool shaft directly interconnected to said common output shaft means of said cooperating pneumatic cylinders of said high power reciprocable force output device for sequential actuation thereof.

9. Force multiplication device of claim 1 further including an air valve disposed within front and rear faces of rear end cap of low power reciprocable force output device with spool shaft extending through rear face of said rear end cap of said low power reciprocable force output device.

10. Method for multiplication of nominal force of a low power reciprocable force output device, the method comprising:
a) Providing a low power reciprocable force output device including a rear shaft with permanently affixed connection means bearing a recessed portion,
b) Providing a high power reciprocable force output device including a plurality of coaxially aligned, interconnected and cooperating pneumatic cylinders with a common force output shaft bearing a permanently affixed connection means with laterally operable plurality of cam actuated pressure jaws, and with stopping means for said connection means of said low power reciprocable force output device for proper alignment of said plurality of pressure jaws of said connection means of said high power reciprocable force output device and said recessed portion of said connection means of said low power force output device,
c) Providing a coupling means adjoining said low power reciprocable force output device and said high power reciprocable force output device including a cam actuation detail for urging said pressure jaws of said connection means of said high power output device in the inward radial direction upon forward actuation thereof, and
The method finally including, application of compressed air to said low power reciprocable force output device to obtain substantial low force travel followed by engagement of said connection means of said low power reciprocable force output device with said stopping means of said connection means of said high power reciprocable force output device resulting in lateral actuation of said pressure jaws of said connection means of said high power reciprocable force output device under the action of said cam actuation detail of said coupling means resulting in engagement of said pressure jaws of said connection means of said high power reciprocable force output device with said recessed portion of said connection means of said low power reciprocable force output device resulting in said high power reciprocable force output device and said low power reciprocable force output device being mechanically locked followed by application of compressed air to said high power reciprocable force output device resulting in multiplied force of said high power reciprocable force output device being available throughout remainder of stroke of low power reciprocable force output device.

11. The method of claim 10 further including said connection means of said high power reciprocable force output device provided with slidably operable pressure jaws.

12. The method of claim 10 further including said connection means of said high power reciprocable force output device provided with pivotably operable pressure jaws.

13. The method of claim 10 further including said connection means of said high power reciprocable force output device provided with unitized construction including bifurcating pressure jaws.

14. The method of claim 10 further including a single acting spring return low power reciprocable force output device.

15. The method of claim 10 further including a single acting spring return high power reciprocable force output device.

16. Force multiplication device for supplying incremental force, the force multiplication device comprising:
a) A low power reciprocable force output device including a forward shaft and a rear shaft,
b) A high power reciprocable force output device including a plurality of coaxially aligned, interconnected and cooperating pneumatic cylinders with a common force output shaft bearing a permanently affixed connection means with laterally operable plurality of cam actuated pressure jaws, and
c) A coupling means sandwiched between said low power reciprocable force output device and said high power reciprocable force output device including a cam actuation detail for urging said pressure jaws of said high power output device in the inward radial direction upon forward actuation thereof,
Whereby actuation of high power reciprocable force output device at the end of substantial low force stroke of low power reciprocable force output device urges forward movement of said connection means of said high power reciprocable force output device and inward radial extension of said pressure jaws of said connection means of said high power reciprocable force output device under action of said cam actuation detail of said coupling means resulting in direct action between said pressure jaws of said connection means of said high power reciprocable force device and rear face of said rear shaft of said low power reciprocable force output device and proportionately multiplied force of said high power reciprocable force output device being available at forward shaft of low power reciprocable force output device.

17. Force multiplication device of claim 16 wherein said pressure jaws are slidably operable in said connection means of said high power reciprocable force output device.

18. Force multiplication device of claim 16 wherein said pressure jaws are pivotably operable in said connection means of said high power reciprocable force output device.

19. Force multiplication device of claim 16 wherein said connection means of said high power reciprocable force output device is of unitized construction including bifurcating pressure jaws.

20. Force multiplication device of claim 16 wherein said low power reciprocable force output device is a single acting spring return pneumatic cylinder.

21. Force multiplication device of claim 16 wherein said high power reciprocable force output device includes single acting spring return pneumatic cylinders.
